(19) United States
(12) Patent Application Publication
(10) Pub. No.: US 2014/0137169 A1
(43) Pub. Date: May 15, 2014

(54) SIGNAL EXPANSION SELECTION DEVICE

(71) Applicant: ASKEY COMPUTER CORP., NEW TAIPEI CITY (TW)

(72) Inventor: HSIN-LIANG LIN, TAIPEI CITY (TW)

(73) Assignee: ASKEY COMPUTER CORP., NEW TAIPEI CITY (TW)

(21) Appl. No.: 13/743,717

(22) Filed: Jan. 17, 2013

(30) Foreign Application Priority Data
Nov. 13, 2012 (TW) 101142169

(51) Int. Cl. H04N 21/472

(52) U.S. Cl. CPC H04N 21/47202
USPC 725/93

(57) ABSTRACT

A signal expansion selection device receives a plurality of selection data from users to select one of audio-video signals generated from audio-video apparatuses. Each of the audio-video signals selected by a corresponding one of the users is converted into an audio-video datum for use by the user. The signal expansion selection device includes selection ports, a processing unit, multiplexing modules, and audio-video output ports. The selection ports send the selection data to the processing unit. The processing unit processes the selection data with an algorithm to generate a control command. The multiplexing modules select one of the audio-video signals according to the control command. The processing unit decodes and converts the selected audio-video signal to audio-video data and enables the audio-video data to be sent from one of the audio-video output ports.

### CROSS-REFERENCE TO RELATED APPLICATION

This non-provisional application claims priority under 35 U.S.C. §119(a) on Patent Application No(s).101142169 filed in Taiwan, R.O.C. on Nov. 13, 2012, the entire contents of which are hereby incorporated by reference.

### FIELD OF TECHNOLOGY

The present invention relates to signal expansion selection device, and more particularly, to a signal expansion selection device whereby each user selects one of a plurality of audio-video signals generated from a plurality of audio-video apparatuses.

### BACKGROUND

According to the prior art, in case multiple users want to simultaneously receive audio-video data created from a plurality of audio-video signals, each of the users has to purchase a plurality of audio-video apparatuses for use in creating the audio-video signals; as a result, the audio-video apparatuses are available to a single user only, and the users can only access one said audio-video apparatuses simultaneously.

Accordingly, it is imperative to provide a device whereby multiple users can access the audio-video apparatuses simultaneously.

### SUMMARY

It is an objective of the present invention to provide a signal expansion selection device which enables a plurality of users to select a plurality of audio-video signals generated from a plurality of audio-video apparatuses and displays to each of the users the audio-video data created in accordance with the audio-video signals (including audio signals and video signals) selected by the user.

Another objective of the present invention is to provide the signal expansion selection device whereby a user selects one of a plurality of audio-video signals generated from the audio-video apparatuses by changing and/or expanding a plurality of audio-video apparatuses (such as audio-video apparatuses which comply with audio-video communication protocols of digital video broadcast (DVB), digital video satellite broadcast (DVB-S), digital video cable broadcast (DVB-C), digital video wireless broadcast (DVB-T), and handheld digital TV digital video broadcast (DVB-H)) readily.

In order to achieve the above and other objectives, the present invention provides a signal expansion selection device for receiving a plurality of selection data from a plurality of users, respectively, to select one of a plurality of audio-video signals generated from a plurality of audio-video apparatuses, respectively, and converting the audio-video signal selected by a corresponding one of the users into a audio-video data for use by the corresponding one of the users. The signal expansion selection device comprises a plurality of selection ports, a processing unit, a plurality of multiplexing modules, and a plurality of audio-video output ports. The selection ports receive the selection data. The processing unit connects to the selection ports, processes the selection data with an algorithm to generate control commands and output the control commands, and decodes and converts the audio-video signals into the audio-video data with the algorithm. The multiplexing modules each have a plurality of input ports, a control port, and a transmission port. The input ports are connected to the transmission port to define a plurality of data transmission paths therebetween, respectively. The control port and the transmission port are connected to the processing unit. The multiplexing modules each receive the audio-video signals via the input ports, respectively. The control port of each of the multiplexing modules receives the control commands to thereby select one of the data transmission paths whereby the audio-video signals are sent to the processing unit via the transmission ports. The audio-video output ports are connected to the processing unit and adapted to output the audio-video data associated with the selection data.

Compared with the prior art, the present invention provides a signal expansion selection device which enables a plurality of users to select a plurality of audio-video signals generated from a plurality of audio-video apparatuses and displays to each of the users the audio-video data created in accordance with the audio-video signals selected by the user.

Furthermore, once audio-video apparatuses are expanded by means of the signal expansion selection device of the present invention, the users are able to select the audio-video signals generated from the new audio-video apparatuses.

### BRIEF DESCRIPTION OF THE DRAWING

Objectives, features, and advantages of the present invention are hereunder illustrated with specific embodiments in conjunction with the accompanying drawing, in which:

FIG. 1 is a schematic block diagram of a signal expansion selection device according to an embodiment of the present invention.

### DETAILED DESCRIPTION

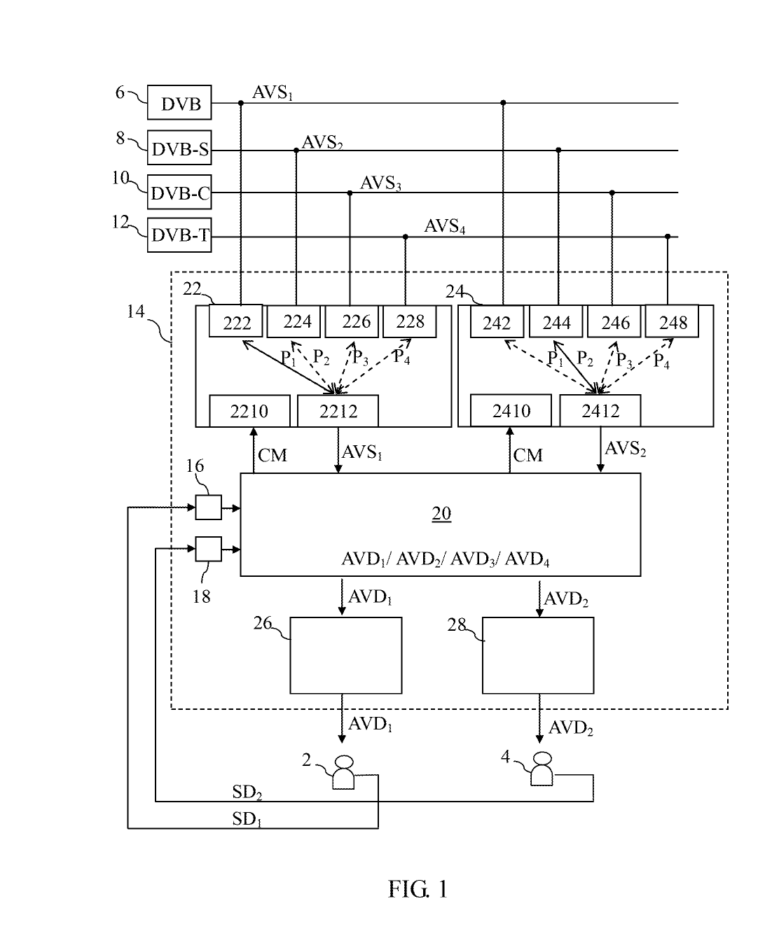

Referring to FIG. 1, there is shown a schematic block diagram of a signal expansion selection device 14 according to an embodiment of the present invention. As shown in FIG. 1, the signal expansion selection device 14 receives a plurality of selection data SD', SD₂ from a plurality of users 2, 4, respectively, to select one of a plurality of audio-video signals AVS₁, AVS₂, AVS₃, AVS₄ generated from a plurality of audio-video apparatuses 6, 8, 10, 12, respectively. The audio-video signal selected by each user, for example, for the sake of illustration and brevity in description, the audio-video signal AVS₁ selected by the user 2, is converted by the signal expansion selection device 14 into a corresponding one of audio-video data AVD₁, AVD₂, AVD₃, AVD₄, that is, the audio-video data AVD₁, for use by user 2. As its name suggested, the audio-video data AVD₁, AVD₂, AVD₃, AVD₄ each contain audio data and video data. The users 2, 4 receive the audio-video data AVD₁, AVD₂, AVD₃, AVD₄ through a monitor or a TV set.

The audio-video apparatuses 6, 8, 10, 12 comply with audio-video communication protocols of digital video broadcast (DVB), digital video satellite broadcast (DVB-S), digital video cable broadcast (DVB-C), digital video wireless broadcast (DVB-T), and handheld digital TV digital video broadcast (DVB-H).

In this embodiment, the audio-video apparatuses 6, 8, 10, 12 are exemplified by DVB, DVB-S, DVB-C, and DVB-T, respectively. The audio-video apparatuses 6, 8, 10, 12 generate digital video broadcast signal AVS₁, digital video satellite broadcast signal AVS₂, digital video cable broadcast signal AVS₃, and digital video wireless broadcast signal AVS₄, respectively. Furthermore, the audio-video apparatuses 6, 8, 10, 12 can also be exemplified by multimedia storage devices (such as a hard disk drive, a DVD player, and a BD player.) Likewise, the multimedia storage devices generate the audio-video signals AVS₁, AVS₂, AVS₃, AVS₄.

The signal expansion selection device 14 comprises a plurality of selection ports 16, 18, a processing unit 20, a plurality of multiplexing modules 22, 24, and a plurality of audio-video output ports 26, 28.

The selection ports 16, 18 receive the selection data SD₁, SD₂. The users 2, 4 create the selection data SD₁, SD₂ with a data generator (not shown), such as an infrared remote control, a keyboard, or a mouse.

In this embodiment, it is presumed that the user 2 enters the selection data SD₁ for selecting the audio-video signal AVS₁, and that the user 4 enters the selection data SD₂ for selecting the audio-video signal AVS₂.

The processing unit 20 is connected to the selection ports 16, 18. The processing unit 20 processes the selection data SD₁, SD₂ with an algorithm (not shown) to generate control commands CM, respectively, and sends the control commands CM to the multiplexing modules 22, 24, respectively.

In another embodiment, the processing unit 20 generates a plurality of control commands (not shown) with the algorithm (not shown) and sends the control commands CM to the multiplexing modules 22, 24, respectively. In yet another embodiment, the processing unit 20 delivers the control commands CM to control ports 2210, 2410 of the multiplexing modules 22, 24 one by one to thereby control the multiplexing modules 22, 24 one by one, and, in this regard, both the lag between two consecutive instances of the aforesaid delivery and the lag between two consecutive instances of the aforesaid control are short enough to be unperceivable.

In this embodiment, the multiplexing module 22 enables the user 2 to select one of the audio-video signals AVS₁, AVS₂, AVS₃, AVS₄, whereas the multiplexing module 24 enables the user 4 to select one of the audio-video signals AVS₁, AVS₂, AVS₃, AVS₄.

The multiplexing module 22 comprises four input ports 222, 224, 226, 228, the control port 2210, and a transmission port 2212. The input ports 222, 224, 226, 228 comply with audio-video communication protocols of high definition multimedia interfaces, coaxial cables, display ports, and portable digital medium interfaces.

The input ports 222, 224, 226, 228 are connected to the audio-video apparatuses 6, 8, 10, 12 for receiving the audio-video signals AVS₁, AVS₂, AVS₃, AVS₄, respectively. The input ports 222, 224, 226, 228 are connected to the transmission port 2212 to define four data transmission paths P₁, P₂, P₃, P₄ therebetween, respectively. Both the control port 2210 and the transmission port 2212 are connected to the processing unit 20. The multiplexing module 22 is connected to the audio-video apparatuses 6, 8, 10, 12 via the input ports 222, 224, 226, 228 to receive the audio-video signals AVS₁, AVS₂, AVS₃, AVS₄, respectively. The control port 2210 of the multiplexing module 22 receives the control command CM. The multiplexing module 22 selects one of the data transmission paths P₁, P₂, P₃, P₄ according to the control command.

In this embodiment, the user 2 enters the selection data SD₁ for selecting the audio-video signal AVS₁, and thus the multiplexing module 22 selects the data transmission path P₁ whereby the audio-video signal AVS₁ is sent to the processing unit 20.

Similarly, the multiplexing module 24 comprises four input ports 242, 244, 246, 248, the control port 2410, and a transmission port 2412. In this embodiment, the input ports 242, 244, 246, 248 are connected to the input ports 222, 224, 226, 228, respectively, to jointly receive the audio-video signals AVS₁, AVS₂, AVS₃, AVS₄, respectively.

The input ports 242, 244, 246, 248 are connected to the transmission port 2412 to define four data transmission paths P₁, P₂, P₃, P₄ therebetween, respectively. The control port 2410 and the transmission port 2412 are connected to the processing unit 20. The multiplexing module 24 is connected to the audio-video apparatuses 6, 8, 10, 12 via the input ports 242, 244, 246, 248 to receive the audio-video signals AVS₁, AVS₂, AVS₃, AVS₄, respectively. The control port 2410 of the multiplexing module 24 receives the control command CM. The multiplexing module 24 selects one of the data transmission paths P₁, P₂, P₃, P₄ according to the control command CM. In this embodiment, the user 4 enters the selection data SD₂ for selecting the audio-video signals AVS₂, and thus the multiplexing module 24 selects the data transmission path P₂ whereby the audio-video signal AVS₂ is sent to the processing unit 20.

Furthermore, the audio-video signal AVS₁ sent from the multiplexing module 22 and the audio-video signal AVS₂ sent from the multiplexing module 24 are decoded and converted by the processing unit 20 into the audio-video data AVD₁ and the audio-video signal AVD₂, respectively, using the algorithm (not shown).

The processing unit 20 sends the audio-video data AVID' to the audio-video output port 26 from which the user 2 receives the audio-video data AVID' selected. Similarly, the processing unit 20 sends the audio-video data AVD₂ to the audio-video output port 28 from which the user 4 receives the audio-video data AVD₂ selected. Furthermore, to render it easy to connect the audio-video output ports 26, 28 to a monitor or a TV set, the audio-video output ports 26, 28 comply with audio-video communication protocols of high definition multimedia interfaces, coaxial cables, display ports, and portable digital medium interfaces.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

1. A signal expansion selection device for receiving a plurality of audio-video signals simultaneously and receiving a plurality of selection signals from a plurality of users, respectively, to select one of the plurality of audio-video signals and converting the audio-video signal selected by a corresponding one of the plurality of users into an audio-video data, and sending the audio-video data to each of the plurality of users simultaneously, the signal expansion selection device comprising:
a plurality of selection ports for receiving the selection data;
a processing unit connecting to the plurality of selection ports, processing the selection signals with an algorithm to generate control commands, and decoding and converting the audio-video signals into the audio-video data with the algorithm;
a plurality of multiplexing modules each having a plurality of input ports, a control port, and a transmission port, the plurality of input ports being connected to the transmission port to define a plurality of data transmission paths therebetween, respectively, wherein the control port and the transmission port are connected to the processing unit, wherein the processing unit sends the control commands to each of the plurality of control ports of the plurality of multiplexing modules, respectively, and the plurality of multiplexing modules each receive the audio-video signals via the plurality of input ports, respectively, wherein the control port of each of the plurality of multiplexing modules receives the control commands to thereby select one of the plurality of data transmission paths according to the control commands, such that a corresponding one of the audio-video signals is sent to the processing unit via a corresponding one of the transmission ports; and
a plurality of audio-video output ports connected to the processing unit and adapted to output simultaneously the audio-video data associated with the selection data, wherein the audio-video data are at least one of identical and different.

2. The signal expansion selection device of claim 1, wherein the processing unit sends the control commands to the plurality of control ports of the plurality of multiplexing modules one by one.

3. The signal expansion selection device of claim 1, wherein the processing unit further generates a plurality of control commands with the algorithm and sends the control commands to the plurality of control ports of the plurality of multiplexing modules, respectively.

4. The signal expansion selection device of claim 1, wherein the plurality of input ports of the plurality of multiplexing modules are connected to the audio-video apparatuses, respectively, to receive the audio-video signals, respectively.

5. The signal expansion selection device of claim 1, wherein the audio-video output ports and the input ports comply with audio-video communication protocols of high definition multimedia interfaces, coaxial cables, display ports, and portable digital medium interfaces.
